(19) United States
(12) Patent Application Publication
(10) Pub. No.: US 2011/0115864 A1
(43) Pub. Date: May 19, 2011

(54) METHOD FOR DRYING A PRINTING SUBSTRATE AND/OR A PRINTING MEDIUM LOCATED THEREON AND A PRINTING MACHINE

(76) Inventors: Domingo Rohde, Kiel (DE); Knut Behnke, Flintbek (DE)

(21) Appl. No.: 13/055,730

(22) PCT Filed: Jun. 29, 2009
(86) PCT No.: PCT/EP2009/058080

§ 371 Date: Jan. 25, 2011

(30) Foreign Application Priority Data
Jul. 31, 2008 (DE) 102008035755.3

(51) Int. Cl. B41J 2/01

(52) U.S. Cl. 347/102

(57) ABSTRACT

The patent application describes a method for drying a printing substrate and/or a printing medium located thereon in a printing machine with at least one first and one second microwave applicator, the second microwave applicator being arranged, viewed in transport direction of the printing substrate, downstream of and adjacent to the first microwave applicator. The method comprises the steps of transporting the printing substrate past the first and the second microwave applicators, introducing microwaves into the printing substrate and the printing medium by means of the first microwave applicator, detecting the microwave power not absorbed by the printing substrate and the printing medium, and introducing microwaves into the printing substrate and the printing medium by means of the second microwave applicator, with the microwave power made available by the second microwave applicator being controlled as a function of the microwave power of the first microwave applicator that was not absorbed by the printing substrate and the printing medium. The method is particularly suitable for multi-color printing. Further described is a printing machine comprising at least one printing unit for applying a moist printing medium to a printing substrate, at least one drying unit for drying the printing medium and/or the printing substrate, and at least one transport unit for successively transporting the printing substrate through the at least one printing unit and the drying unit. The drying unit comprises a first and a second microwave applicator, said second microwave applicator being arranged, viewed in transport direction of the printing substrate, downstream of and adjacent to the first microwave applicator, and also comprises a first sensor unit in the region of the first microwave applicator for detecting the microwave power not absorbed by the printing substrate and the printing medium, and a control unit which communicates with said sensor unit in order to control the second microwave applicator on the basis of an output signal of said sensor unit.

### TECHNICAL FIELD OF THE INVENTION

The present invention relates to a method for drying a printing substrate and/or a printing medium located thereon in a printing machine, as well as a printing machine

### BACKGROUND ART

In printing technology it is known to print, on the one hand, web-shaped printing substrates and, on the other hand, individual sheet-shaped printing substrates. When printing a web-shaped printing substrate, the printing substrate, as a rule, is unwound from a roll and moved past one or more printing units of a printing machine, where a printing medium, for example ink, is applied to the web-shaped printing substrate. Subsequently, the printing substrate with the ink is moved past a drying device in order to dry said ink. For this, the use of a microwave applicator for the drying device is known, said applicator introducing microwave energy into the ink and into the web-shaped printing substrate in order to directly act on the moisture contained therein, to evaporate said moisture and, as a result of this, to dry the printing substrate and the ink. Viewed in transport direction of the printing substrate, the drying device may be provided downstream of the printing unit(s). However, for a printing machine comprising a plurality of printing units, it is also possible to provide a plurality of drying units between the individual printing units, as well as, viewed in the direction of movement of the printing substrate, an additional drying unit downstream of the last printing unit.

In particular, the microwave applicator may be a resonance-type applicator comprising two applicator elements that are directed toward each other and that form a gap between them for passage of the web-shaped printing substrate. A diaphragm outside the application region can be used for coupling in the microwave energy. A particularly suitable type of microwave applicator is known from publication DE-10 2005 042 858 A1, said publication going back to the applicant of the present patent application and, in so far, being made the subject matter of the present application in order to avoid repetitions.

Depending on ink coverage, a specific amount of power is required for drying a printed image in order to dry the printing substrate and the ink to a desired value. Consequently, in areas with low ink coverage, obviously a lower power introduction is required than in areas with a greater ink coverage.

In order to provide sufficient drying, it is possible to adjust the microwave power to the greatest expected ink coverage. When areas with low ink coverage are dried, a large portion of the microwave power is not required for drying and will degrade unused.

An adaptation of the respective microwave power based on information of the printed image, and thus regarding the applied amount of ink, would be possible in principle. However, the exact amount of applied ink would have to be known for each printing unit and be made available as information for the drying unit. The amount of data required therefor would be sizable and, moreover, would have to be processed very rapidly in a continuous ink jet printing process in a web machine of the above type. Furthermore, non-linear processes during the drying operation such as, for example, interactions of paper and ink, and heating and air flow inside the printing machine, would have to be taken into account, which would be very expensive and complex.

### SUMMARY OF THE INVENTION

Therefore, the object of the present invention is to provide a method for drying a printing substrate and/or a printing medium located thereon by means of microwaves, said method overcoming one or more of the aforementioned problems. Furthermore, it is an object of the present invention to provide a printing machine which can be used for drying a printing substrate and/or a printing medium located thereon in an efficient manner.

In accordance with the invention, this object is achieved with a method according to claim 1, as well as with a printing machine according to claim 15. Additional embodiments of the invention result from the respective subclaims.

In particular, a method is provided for drying a printing substrate and/or a printing medium located thereon in a printing machine with at least one first and one second microwave applicator, the second microwave applicator being arranged, viewed in transport direction of the printing substrate, downstream of and adjacent to the first microwave applicator. In accordance with the method, the printing substrate is transported past the first and the second microwave applicators, and the first microwave applicator is used to introduce microwaves into the printing substrate and the printing medium. Then, the microwave power not absorbed by the printing substrate and the printing medium is determined, and the second microwave applicator is used to introduce microwaves into the printing substrate and the printing medium, with the microwave power made available by the second microwave applicator being controlled as a function of the microwave power from the first microwave applicator that was not absorbed by the printing substrate and the printing medium. The above method makes it possible to control the microwave power introduced into the printing substrate and/or the printing medium in a simple and reliable manner as a function of the coverage with printing medium. Consequently, the proportion of unused microwave power can be reduced.

In one embodiment, additional information relating to the amount and/or distribution of the printing medium on the printing substrate is input into the control of the second microwave applicator in order to avoid, for example, rapid changes in the control and to avoid big surges. Preferably, the additional information is made available by at least one printing unit of the printing machine and/or by a control device for at least one printing unit of the printing machine.

In order to protect a microwave source of the second microwave applicator, the above-described method preferably limits power surges inside the second microwave applicator to a maximum of 40% of the total power of the corresponding microwave source. Furthermore, the alternating frequency with respect to the power control is preferably limited on the second microwave applicator. For this, for example, an output signal of a sensor which detects the microwave power not absorbed by the printing substrate and the printing medium, may be subjected to low-pass filtering, in which case the control of the second microwave applicator then occurs as a function of the filtered signal. Alternatively, it is also possible to average, over a prespecified period of time, a plurality of output signals of a sensor, said sensor detecting the microwave power that has not been absorbed by the printing substrate and the printing medium.

Advantageously, it is also possible with the above-described method to detect the microwave power of the second microwave applicator that has not been absorbed by the printing substrate and the printing medium and to allow the thusly detected value to be input into the control of the microwave power of the second microwave applicator. For this, the microwave power of the second microwave applicator can be adjusted, for example, in such a manner that at least 20% of the microwave power introduced into the printing substrate and the printing medium is not absorbed.

The invention is particularly suitable for a method for the production of a multi-color print on a printing substrate, wherein, in order to produce the multi-color print, successive printing media having different colors are applied superimposed on at least partial areas of the printing substrate, at least the partial areas of the printing substrate and/or the printing medium being dried after the application of a first printing medium and before the application of an additional printing medium, in that a method in accordance with the previous claims is used. Through this method, a homogeneous drying of the printing substrate to a specific moisture range is possible before passage through a corresponding printing unit so that essentially the same conditions regarding moisture prevail in the printing units. For this, the printing substrate is preferably a web-shaped substrate that is continuously moved past the corresponding printing units of a multi-color printing machine, and drying takes place continuously in the regions between the printing units. Preferably, an additional corresponding drying step is performed after the last printing unit. Preferably, the printing medium is applied to the printing substrate in liquid form by means of an ink jet.

The object to be achieved by the invention is also achieved by a printing machine comprising at least one printing unit for applying a moist printing medium to a printing substrate, at least one drying unit for drying the printing medium and/or the printing substrate, and at least one transport unit for successively transporting the printing substrate through the at least one printing unit and the drying unit. In this arrangement, the at least one drying unit comprises a first and a second microwave applicator, the second microwave applicator being arranged, viewed in transport direction of the printing substrate, downstream of and adjacent to the first microwave applicator, a first sensor unit in the region of the first microwave applicator for detecting the microwave power not absorbed by the printing substrate and the printing medium, and a control unit which communicates with said sensor unit in order to control the second microwave applicator on the basis of an output signal of said sensor unit. Such a printing machine permits the advantages that have already been described above.

Preferably, the control unit communicates with at least one printing unit of the printing machine and/or the control device for at least one printing unit of the printing machine in order to obtain information regarding the applied amount of printing medium and/or said medium's distribution on the printing substrate, said control unit being capable of including this information in the control of the second microwave applicator. For one embodiment of the invention, means for limiting power surges of the second microwave applicator to a maximum of approximately 40% of its total power and/or means for limiting an alternating frequency with respect to the power control of the second microwave applicator are provided. The means may comprise a low-pass filter, for example.

The printing machine may also comprise a second sensor unit in the region of the second microwave applicator, said sensor unit communicating with the control unit and being used to determine microwave power that has not been absorbed by the printing substrate and the printing medium in this region, the control unit being capable of taking into account information of the second sensor unit in the control of the microwave power of the second microwave applicator. Preferably, the at least one transport unit is suitable for the continuous transport of the web-shaped substrate along the at least one printing unit and the at least one drying unit.

In one embodiment of the invention, the microwave applicators are of the TE10n type with a 180° deflection, said type generating essentially parallel regions of a standing wave, wherein the maxima are offset relative to each other. As a result of this, it is possible to achieve uniform drying across the width of the printing substrate.

Preferably, the printing units of the printing machine are ink jet printing units, whereby, in particular, a plurality of printing units and a corresponding plurality of drying units are provided, with a drying unit being provided between adjacent printing units.

### BRIEF DESCRIPTION OF THE DRAWINGS

Hereinafter, the invention is explained in detail with reference to the drawings.

They show in

FIG. 1 a schematic side view of a printing machine in accordance with the present invention;

FIG. 2 a schematic side view of a drying unit of the printing machine in accordance with FIG. 1; and

FIG. 3 a schematic plan view of a drying unit of the printing machine in accordance with FIG. 1.

### DETAILED DESCRIPTION OF THE INVENTION

Information regarding location and direction used in the description hereinafter primarily refers to the illustrations in the drawings and is thus not to be considered as being restrictive. However, such information may also refer to a preferred final arrangement.

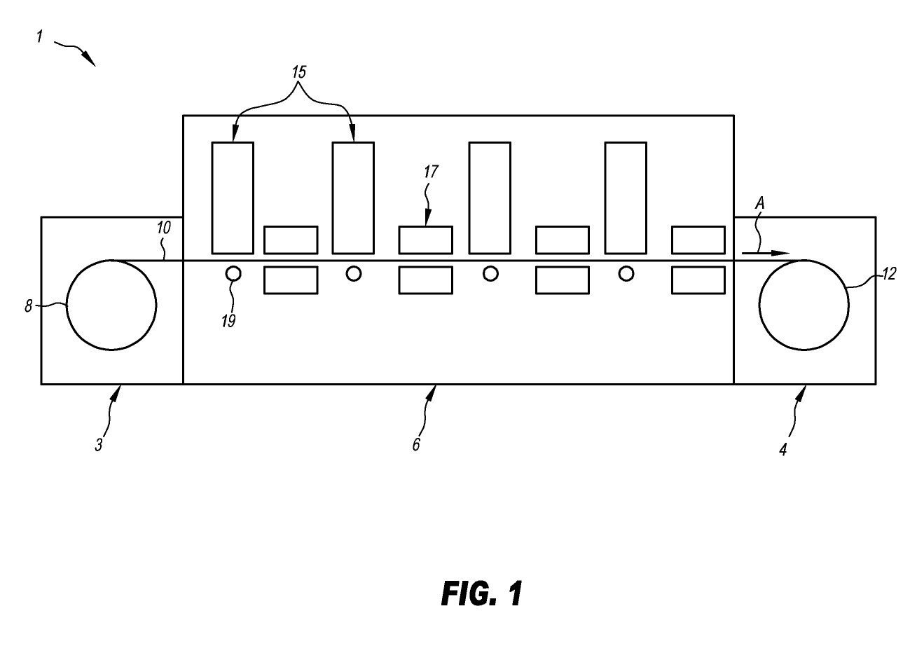

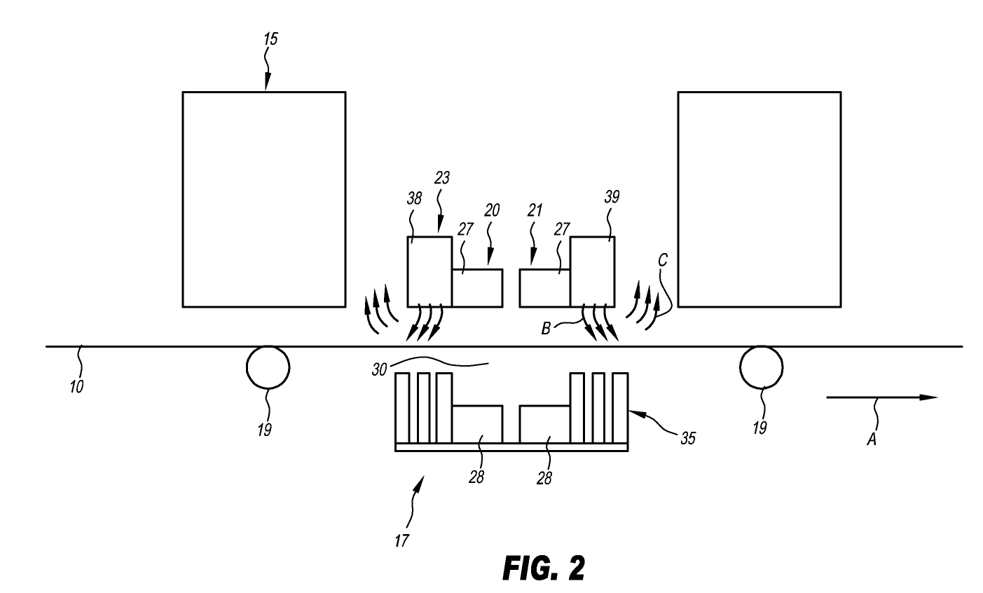

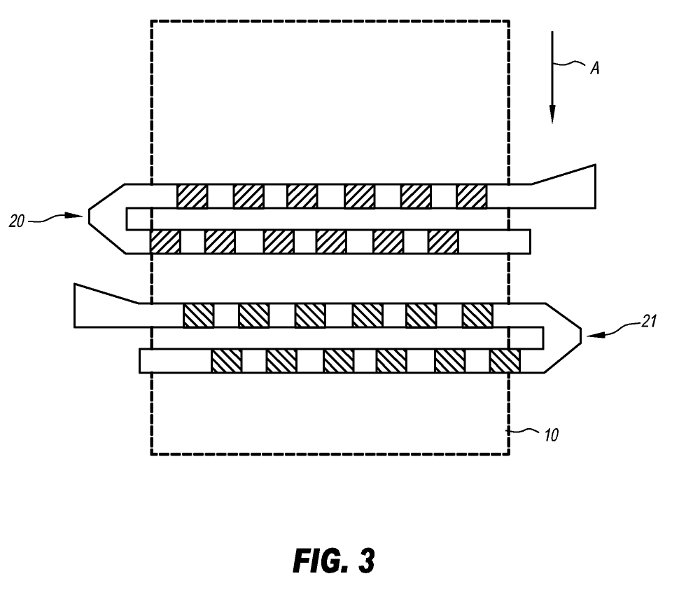

FIG. 1 shows a schematic side view of a printing machine 1. FIG. 2 shows a schematic side view of a drying unit of the printing machine 1, and FIG. 3 shows a schematic plan view of the drying unit.

The printing machine 1 comprises a feeder 3, an output device 4, as well as a printing region 6 in between. A printing substrate roll 8 is rotatably supported in the feeder 3, from which roll a printing substrate 10 is guided through the printing region 6 to a printing substrate take-up roll 12 in the output device 4. During a printing operation, the printing substrate 10 is conveyed from the roll 8 to the roll 12, i.e., via a plurality of guide and transport rollers 19, in the printing region 6, only a few of said rollers being shown to simplify the illustration. In FIG. 1, in order to simplify the illustration, the printing substrate 10 extends in a linear manner through the printing region 6, even though, as a rule, said printing substrate is moved on a non-linear path through the printing region 6.

In the drawing in accordance with FIGS. 1 and 2, the printing substrate 10 is moved from left to right through the printing region 6 during a printing operation, as is indicated by the arrow A.

The printing region 6 comprises a plurality of printing units 15, a plurality of drying devices 17, as well as a plurality of guide and transport rollers 19. Four of the guide and transport rollers 19 are schematically shown in FIG. 1, however, as a rule, a substantially greater number is provided, said rollers conveying the printing substrate 10 along a non-linear transport path through the printing region 6.

Four of the printing units 15 are provided in FIG. 1, thus potentially making the printing machine 1 in accordance with FIG. 1 suitable for a four-color print. However, depending on the use, it is also possible to provide a number of printing units that is different therefrom. In a preferred embodiment of the invention, the printing units 15 are ink jet printing units, however, they may also be of a different type.

Viewed in transport direction, a drying device 17 is provided between the each of respective printing units and, also viewed in transport direction, such a drying device is provided after the last printing unit, said drying devices being explained in greater detail with reference to FIG. 2 and FIG. 3.

Each of the drying devices 17 comprises two microwave applicators 20, 21, as well as a gas flow unit 23. Viewed in the direction of movement of the printing substrate 10, the microwave applicator 20 is arranged upstream of the microwave applicator 21.

Each of the microwave applicators 20, 21 is of the resonance type with two applicator elements 27, 28 directed toward each other, said elements forming a gap 30 between them for the passage of the printing substrate 10. In particular, the microwave applicators 20, 21 used here are intended to be of the TE10n type. Each of the microwave applicators 20, 21 has two adjacent, elongated chambers that communicate with each other via a 180° deflection, i.e., in such a manner, that the maxima of a standing wave in one chamber is offset with respect to the maxima of the standing wave in the other chamber, as is indicated by the lined regions in FIG. 3. Such microwave applicators have been known from DE 10 2005 42 858 A1 going back to the applicant of the present invention, said microwave applicators being in so far made the subject matter of the present application.

The microwaves are coupled into each of the respective microwave applicators 20, 21 by a dedicated, not illustrated, source via a tapering on the face of the respective microwave applicator 20, 21, this being located outside the application region. In the illustration in accordance with FIG. 3, coupling into the adjacent microwave applicators 20, 21 takes place from opposite sides. However, it is also possible to feed microwaves from the same side into the respective microwave applicators 20, 21.

Viewed in transport direction of the printing substrate, at least the upstream microwave applicator 20 comprises means to detect or determine during operation how much of the coupled-in microwave power was absorbed by the printing substrate or by the applied printing medium. Hereinafter, the portion of the microwave power not absorbed is referred to as the reflected microwave power. This reflected microwave power allows a conclusion regarding the moisture in the printing substrate/printing medium at the time of entry into the microwave applicator and, as the case may be, regarding the residual moisture at the time of exit. Information relating to the reflected microwave power can now be used in a control device for the control of the microwave of the downstream microwave applicator 21, again viewed in transport direction of the printing substrate, as will be explained in greater detail hereinafter.

The applicator elements 27, 28 are arranged vertically above each other, whereby, adjacent to the applicator element 28 located at the bottom, a choke structure 35 is provided, said choke structure comprising rod elements located adjacent to the lower applicator element 28 and comprising the surface of the gas flow unit 23 that delimits the gap 30 adjacent to the upper applicator element 27.

The gas flow unit 23 is provided adjacent to the upper applicator element 27, said gas flow unit comprising, in conveying direction A of the printing substrate 10, gas application devices 38, 39 upstream and downstream of the applicator elements 27 of the microwave applicators 21, 20. As is shown by arrows B in FIG. 2, the gas application devices 38, 39 direct a gas flow at the surface of the printing substrate 10. This gas flow is extracted upward by a device that is not illustrated in detail, as is indicated by the corresponding arrows C in FIG. 2. This may be a general upward extraction in the printing machine 1, or it may be a targeted extraction in the region of the gas application devices 38, 39. For this, the extraction device should be adjusted in such a manner that it extracts at least the air/gas amount applied by the gas application devices 38, 39. An additional gas application and/or gas extraction may also be provided between the microwave applicators 20, 21.

Hereinafter follows a more detailed description of the operation of the printing machine 1 and, in particular, of the drying units 17. During the operation of the printing machine 1, the printing substrate 10, for example a paper web, is conveyed continuously in a suitable manner from the feeder 3 through the printing region 6 to the output device 4. While the printing substrate 10 moves through the printing region 6, the respective printing units 15 apply, in accordance with a prespecified print job, a moist printing medium such as, e.g., ink, to the printing substrate. In this process, the ink coverage to be applied by the respective printing units 15 is not continuous, as a rule, but fluctuates depending on the print job. Consequently, also the respective moisture application fluctuates accordingly.

After each pass through one of the printing units, the printing substrate passes through a respective printing unit 17, in which the printing substrate and/or the printing medium are dried. A first drying occurs in the microwave applicator 20 located upstream, viewed in transport direction of the printing substrate, while further drying takes place in the microwave applicator 21 located downstream, viewed in transport direction of the printing substrate. In this process, the microwave source of the microwave applicator 21 located downstream, viewed in transport direction of the printing substrate, is controlled as a function of the reflected microwave power in the region of the microwave applicator 20 located upstream, viewed in the transport direction of the printing substrate, i.e., the microwave power that is not absorbed by the printing substrate or the ink. A minimal reflection (i.e., high absorption) indicates high moisture at the time of entry into the microwave applicator 20 and thus also indicates a correspondingly high residual moisture. In contrast, a high reflection (i.e., low absorption) indicates low moisture at the time of entry into the microwave applicator 20 and thus also indicates a correspondingly low residual moisture.

This information relating to the reflected microwave power is now used for the control of the microwave source of the microwave applicator 21 located downstream, viewed in transport direction of the printing substrate, in such a manner that, on the one hand, the energy input may be reduced and, on the other hand, the residual moisture of the printing substrate at the time of exit from the microwave applicator 21 located downstream, viewed in transport direction of the printing substrate, is more homogenous.

The following table shows examples of the power adjustment of the microwave source of the microwave applicator 21 located downstream, viewed in transport direction of the printing substrate, as a function of the reflected microwave power in the region of the microwave applicator 20 located upstream, viewed in transportation direction of the printing substrate. In the table, it is assumed that each of the microwave sources for the two microwave applicators represent sources for a rated power of 6 kW. Of course, also other sources and also other gradations than those shown in Table 1 are possible.

TABLE 1

| P_{MW 20} | Pref_{MW 20} | P_{MW 21} |
|---|---|---|
| 6 kW | 0-1 kW | 6 kW |
| 6 kW | 1-2 kW | 5 kW |
| 6 kW | 2-3 kW | 4 kW |
| 6 kW | 3-4 kW | 3 kW |
| 6 kW | 4-5 kW | 2 kW |
| 6 kW | 5-6 kW | 1 kW |

Here, P_{MW 20} represents the power coupled into the microwave applicator 20, Pref_{MW 20} the microwave power reflected in the region of the first microwave applicator, and P_{MW 21} the power coupled into the microwave applicator 21 as a function of the reflected power. As is obvious from Table 1, the power of the microwave applicator located downstream, viewed in transport direction of the printing substrate, is adjusted as a function of the reflected power on the microwave applicator located upstream, viewed in transport direction of the printing substrate, and thus is adjusted, as it were, by the residual moisture in the printing substrate/printing medium. As a result of this, power is being saved.

In order to protect the microwave source of the microwave applicator located downstream, viewed in transport direction of the printing substrate, from large power surges that could negatively affect useful life, it is possible to limit the minimum or maximum applied power, as is indicated, for example, in Table 2. Table 2 shows an alternative example of a power adjustment of the microwave source of the microwave applicator 21 located downstream, viewed in transport direction of the printing substrate, as a function of the reflected microwave power in the region of the microwave applicator 20 located upstream, viewed in transport direction of the printing substrate.

TABLE 2

| P_{MW 20} | Pref_{MW 20} | P_{MW 21} |
|---|---|---|
| 6 kW | 0-1 kW | 5 kW |
| 6 kW | 1-2 kW | 5 kW |
| 6 kW | 2-3 kW | 4 kW |
| 6 kW | 3-4 kW | 3 kW |
| 6 kW | 4-5 kW | 3 kW |
| 6 kW | 5-6 kW | 3 kW |

As can be seen in Table 2, power surges over 2 kW on the microwave applicator 21 located downstream, viewed in transport direction of the printing substrate, are avoided by appropriate control, consequently protecting the affected source. Of course, such surges may also be avoided by other ratings or in another way.

A high alternating rate of the power made available by the source can also negatively affect the useful life of said source. Consequently, it is possible to incorporate additional information into the control of the source of the microwave applicator 21 located downstream, viewed in transport direction of the printing substrate, in order to avoid brief surges as would occur, for example, in the case of tape-printing. For this purpose, it is possible, for example, to use information originating from a print control via the print job. If, for example, tape-printing takes place, this can be indicated by the print control and, for the duration of tape-printing, the source of the microwave applicator 21 located downstream, viewed in transport direction of the printing substrate, may be operated at an essentially constant value. Larger areas with high ink coverage that may display only brief interruptions can also be signalized accordingly in order to maintain the microwave power at an appropriately high level beyond the region, without intermediate drop.

For example, it is also possible to average the reflected power on the microwave applicator 20 located upstream, viewed in transport direction of the printing substrate, over a specific period of time in order to avoid short-time surges. Also, a detection of a pattern of repeating surges in the reflected power (e.g., bar printing) can be provided, which surges may then be ignored accordingly. In such cases, in particular, the source would be operated at high power and the reduction of power would be prevented.

The above-described printing machine and the corresponding actuation of the microwave applicators of the drying units permit a reduced energy input. Furthermore, it is possible to compensate for incomplete drying by the drying units, at least in part, in the subsequent units. If, for example, the first drying unit in the path of movement of the printing substrate experiences a malfunction and does not provide sufficient drying, the corresponding moisture (after additional printing by the printing unit located downstream, viewed in transport direction of the printing substrate) is detected on the microwave applicator of the subsequent drying unit, said microwave applicator being located upstream, viewed in transport direction of the printing substrate, and the power in the microwave applicator located downstream, viewed in transport direction of the printing substrate, is adjusted accordingly.

The invention has been explained with reference to a preferred embodiment without being restricted to the specific embodiment. In particular, the printing machine may have a different configuration, in which case it is also not necessary to provide drying units between respectively adjacent printing units. It is also possible that the drying units comprise more than two microwave applicators, the microwave applicator located downstream, viewed in transport direction of the printing substrate, being preferably controlled by reflected power on a microwave applicator located upstream, viewed in transport direction of the printing substrate.

1. Method for drying a printing substrate and/or a printing medium located thereon in a printing machine with at least one first and one second microwave applicator, the second microwave applicator being arranged, viewed in transport direction of the printing substrate, downstream of and adjacent to the first microwave applicator, said method comprising the following steps:
transporting the printing substrate past the first and the second microwave applicators;
introducing microwaves into the printing substrate and the printing medium by means of the first microwave applicator;
detecting the microwave power not absorbed by the printing substrate and the printing medium; and
introducing microwaves into the printing substrate and the printing medium by means of the second microwave applicator, with the microwave power made available by the second microwave applicator being controlled as a function of the microwave power of the first microwave applicator that was not absorbed by the printing substrate and the printing medium.

2. Method as in claim 1, wherein the not absorbed microwave power is detected by a sensor, said sensor detecting the reflected microwave power.

3. Method as in claim 1, wherein additional information relating to the amount and/or distribution of the printing medium on the printing substrate is input into the control of the second microwave applicator.

4. Method as in claim 3, wherein the additional information is made available by at least one printing unit of the printing machine and/or by a control device for at least one printing unit of the printing machine.

5. Method as in claim 1, wherein power surges inside the second microwave applicator are limited to a maximum of 40% of the total power of a corresponding microwave source.

6. Method as in claim 1, wherein the alternating frequency with respect to the power control is limited on the second microwave applicator.

7. Method as in claim 6, wherein an output signal of a sensor which detects the microwave power not absorbed by the printing substrate and the printing medium, is subjected to low-pass filtering, and the control of the second microwave applicator then occurs as a function of the filtered signal.

8. Method as in claim 6, wherein, over a prespecified period of time, a plurality of output signals of a sensor which detects the microwave power that has not been absorbed by the printing substrate and the printing medium, is averaged.

9. Method as in claim 1, wherein the microwave power of the second microwave applicator that has not been absorbed by the printing substrate and the printing medium is detected, and the thusly detected value is input into the control of the microwave power of the second microwave applicator.

10. Method as in claim 9, wherein the microwave power of the second microwave applicator is adjusted in such a manner that at least 20% of the microwave power introduced into the printing substrate and the printing medium is not absorbed.

11. Method for the production of a multi-color print on a printing substrate, wherein, in order to produce the multi-color print, successive printing media having different colors are applied superimposed on at least partial areas of the printing substrate, with at least the partial areas of the printing substrate and/or the printing medium being dried after the application of a first printing medium and before the application of an additional printing medium in accordance with a method as in claim 1.

12. Method as in claim 11, wherein the printing substrate is a web-shaped substrate that is continuously moved past the corresponding printing units of a multi-color printing machine, and drying takes place continuously in the regions between the printing units.

13. Method as in claim 12, wherein a drying step is performed after the last printing unit.

14. Method as in claim 11, wherein the printing medium is applied to the printing substrate in liquid form by means of an ink jet.

15. Printing machine comprising at least one printing unit for applying a moist printing medium to a printing substrate, at least one drying unit for drying the printing medium and/or the printing substrate, and at least one transport unit for successively transporting the printing substrate through the at least one printing unit and the drying unit, the at least one drying unit comprising;
a first and a second microwave applicator, the second microwave applicator being arranged, viewed in transport direction of the printing substrate, down-stream of and adjacent to the first microwave applicator;
a first sensor unit in the region of the first microwave applicator for detecting the microwave power not absorbed by the printing substrate and the printing medium; and
a control unit which communicates with said sensor unit in order to control the second microwave applicator on the basis of an output signal of said sensor unit.

16. Printing machine as in claim 15, the sensor unit being capable of detecting reflected microwave power of the first microwave applicator.

17. Printing machine as in claim 15, the control unit communicating with at least one printing unit of the printing machine and/or a control device for at least one printing unit of the printing machine in order to obtain information regarding the applied amount of printing medium and/or said medium's distribution on the printing substrate, said control unit being capable of including this information in the control of the second microwave applicator.

18. Printing machine as in claim 15, with means being provided for limiting power surges of the second microwave applicator to a maximum of approximately 40% of the total power of said microwave applicator.

19. Printing machine as in claim 15, with means being provided for limiting an alternating frequency with respect to the power control of the second microwave applicator.

20. Printing machine as in claim 19, the means comprising a low-pass filter.

21. Printing machine as in claim 15, with a second sensor unit being provided in the region of the second microwave applicator, said sensor unit communicating with the control unit in order to determine microwave power that has not been absorbed by the printing substrate and the printing medium, the control unit being capable of taking into account information of the second sensor unit in the control of the microwave power of the second microwave applicator.

22. Printing machine as in claim 15, the at least one transport unit being suitable for the continuous transport of a web-shaped substrate along the at least one printing unit and the at least one drying unit.

23. Printing machine as in claim 15, the microwave applicators being of the TE10n type with a 180° deflection, said type generating two essentially parallel regions of a standing wave, in which the maxima are offset relative to each other.

24. Printing machine as in claim 15, the printing units being ink jet printing units.

25. Printing machine as in claim 15, with a plurality of printing units and a corresponding plurality of drying units being provided, each drying unit being provided between adjacent printing units.
